(19) United States
(12) Patent Application Publication
(10) Pub. No.: US 2010/0253030 A1
(43) Pub. Date: Oct. 7, 2010

(54) HYBRID ARM FOR AN INDEPENDENT REAR SUSPENSION FOR A MOTOR VEHICLE

(75) Inventors: Armando D'Aponte, Alessandria (IT); Piero Monchiero, Torino (IT); Andrea Santini, Collegno (Torino) (IT)

Correspondence Address: SUGHRUE MION, PLLC, 2100 PENNSYLVANIA AVENUE, N.W., SUITE 800, WASHINGTON, DC, 20037, US

(73) Assignee: SISTEMI SOSPENSIONI S.P.A., Corbetta, Milano (IT)

(21) Appl. No.: 12/744,629

(22) PCT Filed: Dec. 2, 2008
(86) PCT No.: PCT/IB08/55044

§ 371 Date: May 25, 2010

(30) Foreign Application Priority Data
Dec. 3, 2007 (IT) TO2007A000872

(51) Int. Cl. B60G 3/06

(52) U.S. Cl. 280/124.116

(57) ABSTRACT

The arm includes a wheel-side portion for support of a wheel and a body-side portion for connection to the vehicle body, the two arm portions being securely connected to each other by welding. The wheel-side arm portion may be made of cast iron and the body-side arm portion may be made as a steel tubular piece. Alternatively, the wheel-side arm portion is made of cast aluminium and the body-side arm portion is made as an extruded aluminium piece. It is thus possible to combine the high camber stiffness of the wheel-side portion made of cast iron or aluminium with the high compliance in case of impact of the body-side portion made of stamped or extruded steel or aluminium.

The present invention refers to an arm for an independent rear suspension for a motor vehicle.

The arms for independent rear suspensions are currently made of steel, cast iron or aluminium and are generally composed of a plurality of welded pieces which are made of the same material and are obtained by the same manufacturing method, typically by stamping in case of steel, by casting in case of cast iron and by stamping or casting in case of aluminium. Arms wholly made of stamped steel or aluminium ensure high compliance in case of impact, but do not allow to obtain camber stiffness values of the same level as those obtainable with arms wholly made of cast iron or cast aluminium.

It is therefore an object of the present invention to provide an arm for an independent rear suspension for a motor vehicle which offers at the same time very high performances both in terms of stiffness and in terms of safety in case of impact and which also has a reduced weight.

This and other objects are fully achieved according to the invention by virtue of an arm for an independent rear suspension for a motor vehicle having the features defined in appended claim 1.

In short, the invention is based on the idea of providing an arm with a hybrid structure, which comprises a wheel-carrying portion made of cast iron or aluminium and a body connection portion formed by at east one tubular element of steel or aluminium, respectively, obtained by stamping or extrusion.

By virtue of such a hybrid structure it is possible to combine the advantages offered by both the technological solutions (stamping/extrusion and casting): the iron or aluminium casting for the wheel-carrying structure makes it possible to obtain high camber stiffness values, while the use of at least one tubular element of stamped or extruded steel or aluminium for the body connection portion ensures a high compliance in case of impact, with resulting advantages in terms of safety.

Further features and advantages of the invention will result more clearly from the following detailed description, given purely by way of non-limiting example with reference to the appended drawings, in which:

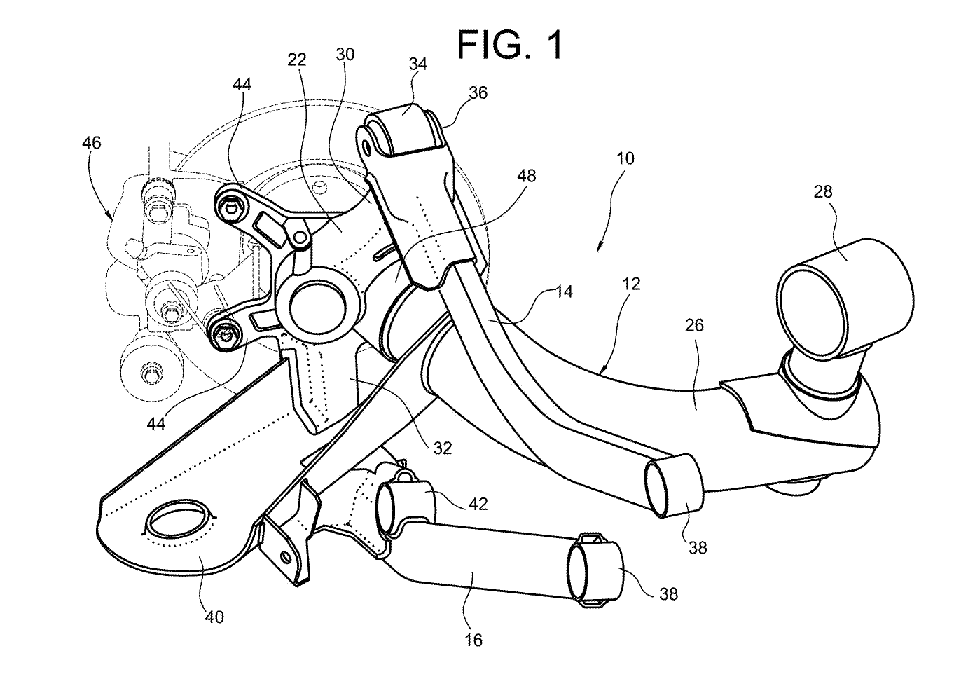

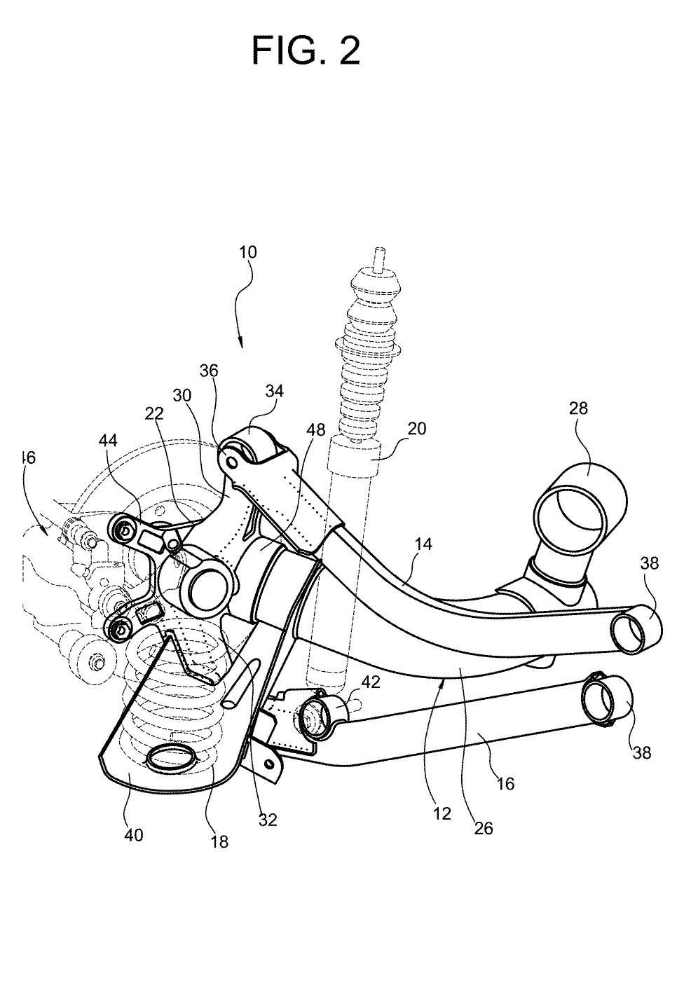

FIGS. 1 and 2 are perspective views of an independent rear suspension for a motor vehicle having an arm according to a preferred embodiment of the invention; and

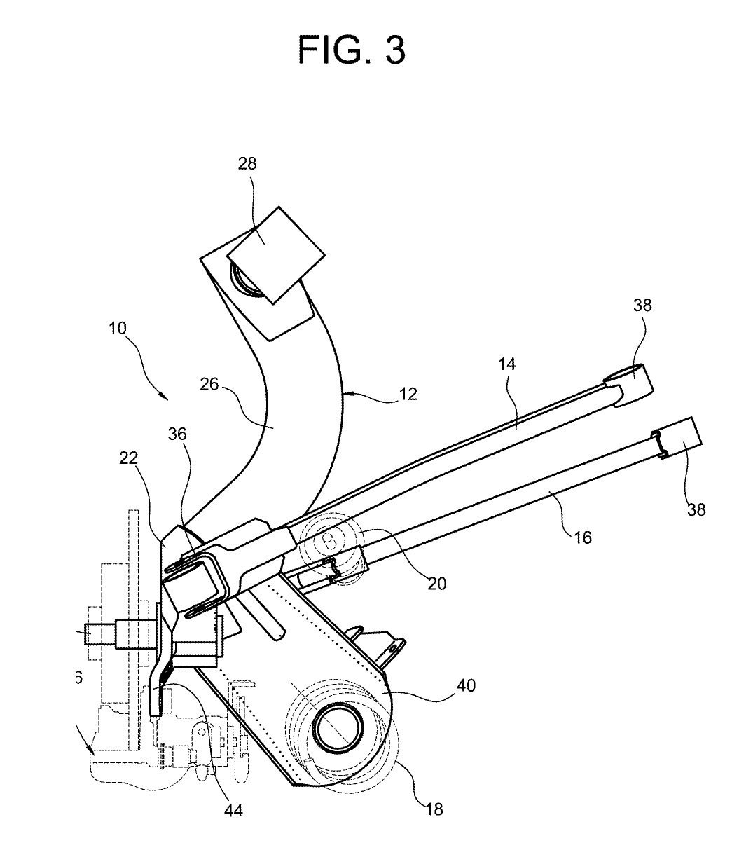

FIG. 3 is a plan view of the suspension of FIGS. 1 and 2.

In the description and the claims which follow, terms such as “longitudinal” and “transverse”, “inner” and “outer”, “front” and “rear”, “upper” and “lower” etc. are to be intended as referred to the mounted condition of the suspension on a vehicle.

With reference to the drawings, an independent rear suspension for a motor vehicle is generally indicated 10 and comprises an arm 12, in the present case a longitudinal arm, a pair of transverse rods 14 and 16, a spring 18 and a shock-absorber 20. The arm 12 comprises a wheel-side portion 22 provided with a spindle 24 (which can be seen in FIG. 3 only) for support of a wheel (not shown) and a body-side portion 26 provided with a bushing seat 28 for articulated connection of the arm 12 to the vehicle body (not shown). The two transverse rods 14 and 16, that is, the upper transverse rod and the lower transverse rod, respectively, are articulately connected at their outer ends to the wheel-side portion 22 of the arm 12 and at their inner ends to the body. More specifically, for connection with the wheel-side portion 22 of the arm 12, that arm portion integrally forms a pair of small arms 30 and 32 which extend upwards and downwards, respectively, and are provided at their free ends with respective bushing seats 34 (of which only the one associated to the upper small arm 30 can be seen), while the rods 14 and 16 are provided at their transversely outer ends with respective fork-like portions 36 for receiving each a respective bushing pins (not shown). On the other hand, for connection with the body the rods 14 and 16 are provided at their transversely inner ends with respective bushing seats 38. The spring 18 rests at its bottom on a plate 40 secured both to the wheel-side portion 22, in particular to the lower small arm 32, and to the body-side portion 26 of the arm 12. The shock-absorber 20 is articulately connected at its lower end to the lower rod 16, and for this purpose the lower rod 16 is provided with a special bushing seat 42. The wheel-side portion 22 of the arm 12 integrally forms also a pair of support brackets 44 for the mounting of a brake caliper 46.

According to a first embodiment of the invention, the wheel-side portion 22 of the arm 12 is integrally made of cast iron, while the body-side arm portion 26 is made as a steel tubular piece. The two arm portions 22 and 26 are firmly secured to each other by welding at a joining tubular portion 48 integrally formed by the body-side arm portion 22. In this case, the spring plate 40 is preferably made as a steel stamped piece and is fixed by welding to the two arm portions 22 and 26.

According to a variant of embodiment of the invention, the wheel-side arm portion is integrally made of cast aluminium, for example gravity die cast aluminium, while the body-side arm portion is made as an extruded piece of aluminium. Also in this case, the two wheel-side and body-side arm portions are firmly secured to each other by welding at a tubular joining portion integrally formed by the body-side arm portion. In this case, the spring plate is preferably made as a stamped piece of aluminium and is fixed by welding to the two arm portions.

Naturally, the principle of the invention remaining unchanged, the embodiments and details of construction may be varied widely with respect to those described and illustrated purely by way of non-limiting example, without thereby departing from the scope of the invention as defined in the appended claims.

For example, although the description and the drawings refer to a longitudinal arm, the invention may be clearly applied to a transverse arm as well.

1. Arm for an independent rear suspension for a motor vehicle, the arm comprising a wheel-side portion for support of a wheel and a body-side portion for connection to the vehicle body, characterized in that the wheel-side portion is formed by a single cast metal piece, in that the body-side portion is formed by at least one stamped or extruded metal piece and in that the two arm portions are securely connected to each other by welding.

2. Arm according to claim 1, wherein the wheel-side arm portion is made of cast iron and wherein the body-side arm portion is made as a steel tubular piece.

3. Arm according to claim 1, wherein the wheel-side arm portion is made of cast aluminium and wherein the body-side arm portion is made as an extruded piece of aluminium.

4. Arm according to claim 1, wherein the wheel-side portion is provided with a wheel-carrying spindle and wherein the body-side portion is provided with a bushing seats for articulated connection of the arm to the vehicle body.

5. Arm according to claim 1, wherein the wheel-side portion integrally forms at least one small arm provided at its free end with a respective bushing seat for articulated connection of the wheel-side portion to at least one further connection member of the suspension.

6. Arm according to claim 1, wherein the wheel-side portion integrally forms at least one support bracket for support of a brake caliper.

7. Independent rear suspension for a motor vehicle, comprising an arm according to claim 1, at least one further connection member articulated on the one hand to the wheel-side portion of the arm and on the other hand to the vehicle body, as well as a spring and a shock-absorber.

8. Suspension according to claim 7, wherein the arm is a longitudinal arm and wherein the suspension further comprises, as the at least one further connection member, a pair of transverse rods.

9. Suspension according to claim 7, further comprising a plate for support of the lower portion of the spring, the plate being made as a stamped piece of metal.

10. Suspension according to claim 9, wherein the spring plate is securely connected by welding both to the wheel-side arm portion and to the body-side arm portion.

11. Suspension according to claim 2, wherein the spring plate is made as a stamped piece of steel.

12. Suspension according to claim 3, wherein the spring plate is made as a stamped piece of aluminium.

13. Suspension according to claim 9, wherein the spring plate is made as a stamped piece of steel.

14. Suspension according to claim 10, wherein the spring plate is made as a stamped piece of steel.

15. Suspension according to claim 9, wherein the spring plate is made as a stamped piece of aluminium.

16. Suspension according to claim 10, wherein the spring plate is made as a stamped piece of aluminium.
